(19) United States
(12) Patent Application Publication
(10) Pub. No.: US 2025/0219386 A1
(43) Pub. Date: Jul. 3, 2025

(54) BOX-LIKE PROTECTION FOR ELECTRICAL CONNECTIONS

(71) Applicant: Leonardo PINI, Firenze (IT)

(72) Inventor: Leonardo PINI, Firenze (IT)

(21) Appl. No.: 18/881,394

(22) PCT Filed: Jun. 12, 2023
(86) PCT No.: PCT/IT2023/050143

§ 371 Date: Jan. 6, 2025

(30) Foreign Application Priority Data
Jul. 8, 2022 (IT) 102022000014425

(51) Int. Cl. H02G 15/113

(52) U.S. Cl. CPC H02G 15/113

(57) ABSTRACT

Box-like protection for electrical connections, including two half-shells that, in cooperation with each other, define an internal seat for a terminal block or similar device for making electrical connections, and at least one opening for the entry/exit of electric cables connectable to the terminal block, and including an internal cables-locking mechanism. The internal cables-locking mechanism is a clamping mechanism including elements formed, inside each half-shell, on opposite sides with respect to the at least one opening, wherein a clamping element has a movable body and the other clamping element has a fixed body such that, in correspondence of the at least one opening, there are two movable clamping bodies and two fixed clamping bodies adapted to clamp a respective cable on four clamping points.

The present invention relates to a box-like protection for electrical connections.

Box-like protections for electrical connections are described for example in EP443694, U.S. Pat. Nos. 52,828,005, 6,265,665 and EP1760856. These documents describe enclosures for electrical connections comprising two elements which can be coupled to each other in a reversible or irreversible manner and which are shaped to define inside them a cavity for a terminal block and a plurality of input/output openings for the cables connected to the terminal block. Said cavity can be filled with a dielectric gel. Further box-like protections for electrical connections are described in DE10209566A1, US2012/0024596A1 and U.S. Pat. No. 5,561,269.

The present invention aims at to simplifying and further facilitating the use of such box-like protections without however reducing the degree of protection offered.

This result has been achieved in accordance with the present invention by adopting the idea of realizing a box-like protection for electrical connections having the features indicated in claim 1. Other features of the present invention are the subject of the dependent claims.

Thanks to the present invention it is possible to simplify and speed up the use of box-like protections for electrical connections and, therefore, to favor their use also in applications which require a large number of them to be quickly mounted. A further advantage offered by the present invention consists in a greater capacity of locking the electric cables thanks to the provision of a plurality of clamping points inside the box-like protection which allow the electric cables to be kept suitably locked.

These and further advantages and characteristics of the present invention will be more and better understood by any person skilled in the art thanks to the following description and the annexed drawings, provided by way of example but not to be considered in a limiting sense, in which:

FIG. I shows a perspective view of a box-like protection for electrical connections in accordance with the present invention in the assembled condition;

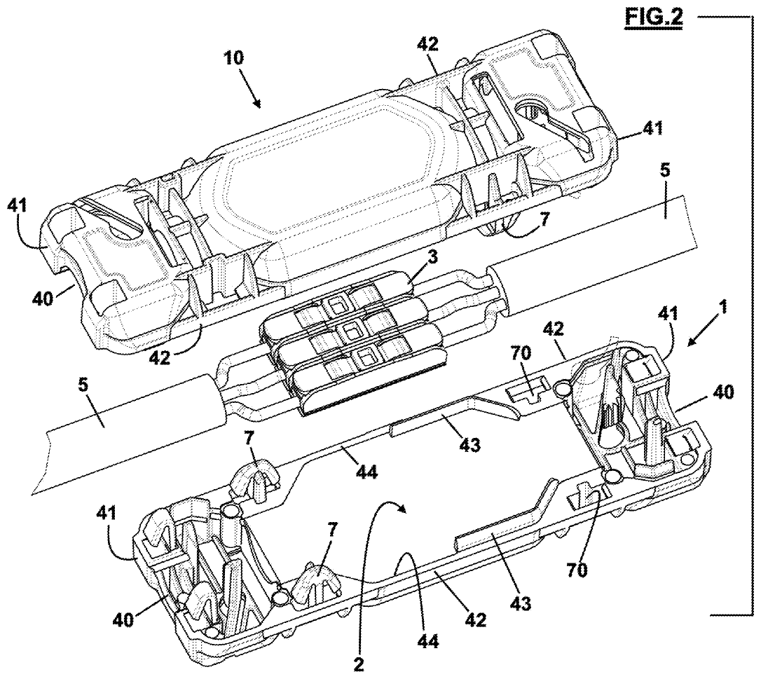

FIG. 2 is an exploded perspective view of the box-like protection of FIG. I;

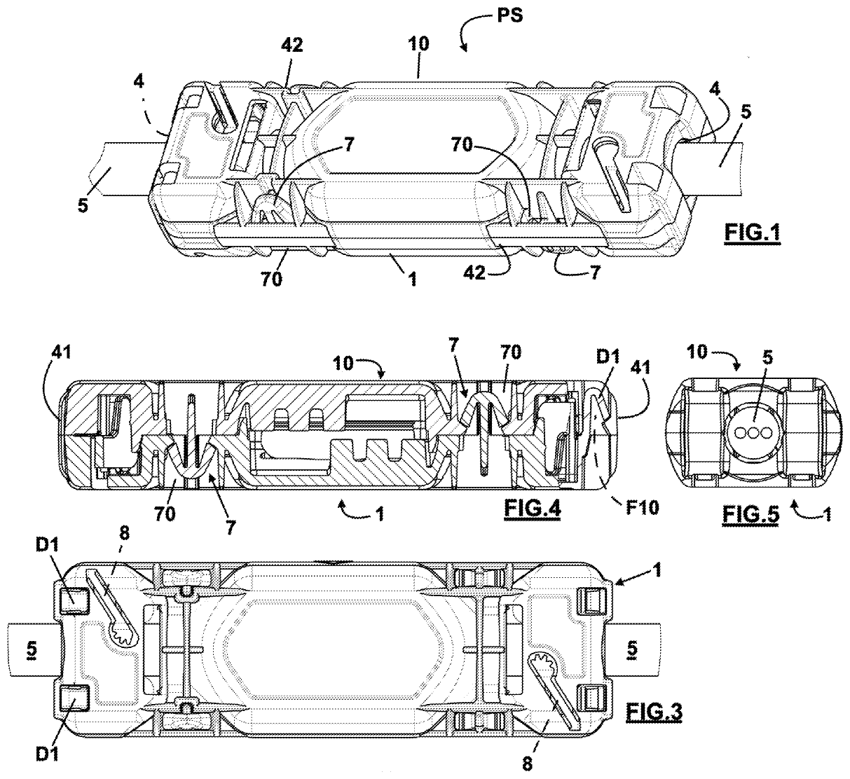

FIG. 3 is a top view of the box-like protection of FIG. 1;

FIG. 4 is a longitudinal section view of the box-like protection of FIG. 1;

FIG. 5 is a cross section view of the box-like protection of FIG. 1;

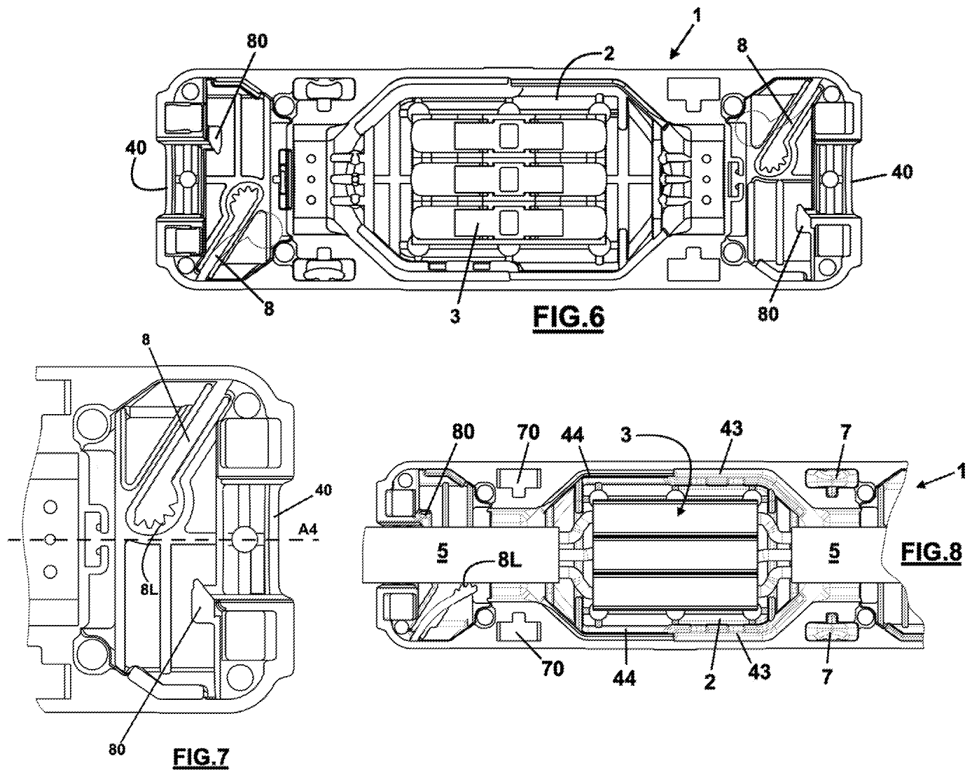

FIG. 6 is a top view of a half-shell of the box-like protection of FIG. 1;

FIG. 7 is a detail of FIG. 6;

FIG. 8 is similar to FIG. 6 but it also illustrates the cables connected to the terminal block;

FIG. 9 is a detail of FIG. 8;

FIG. 10 is a section view showing a detail relating to the reciprocal hooking of the half-shells;

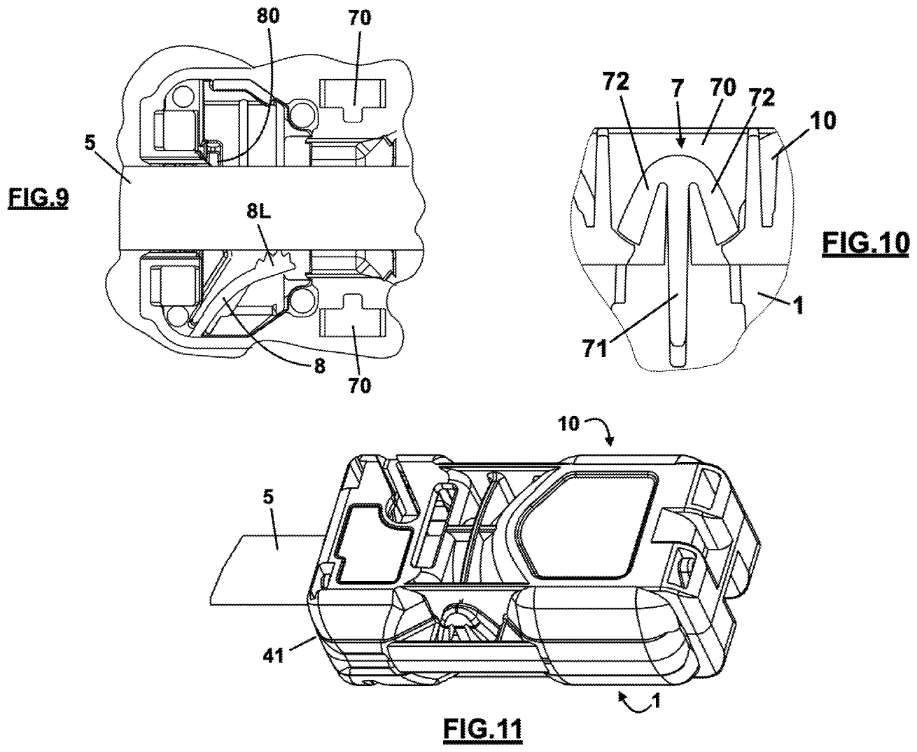

FIG. 11 represents a perspective view of a box-shaped protection for electrical connections according to a further embodiment of the present invention in the assembled condition;

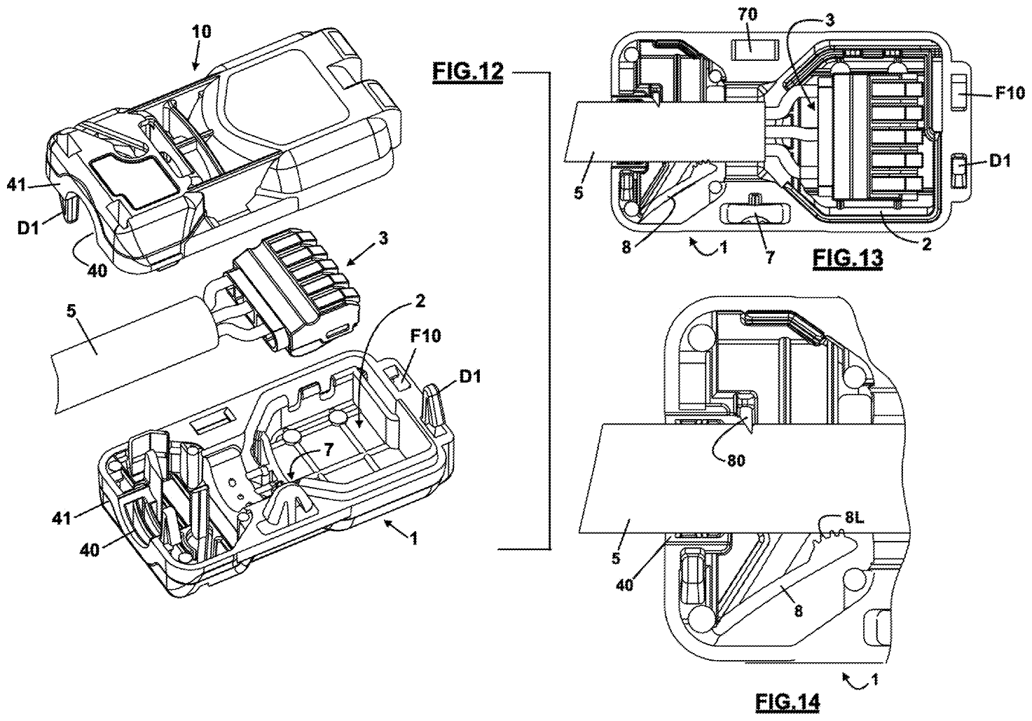

FIG. 12 is an exploded perspective view of the box-like protection of FIG. 11;

FIG. 13 is a top view of a half-shell of the box-like protection of FIG. 11 with a terminal block placed inside to which an electric cable is connected;

FIG. 14 is an enlarged detail of FIG. 13;

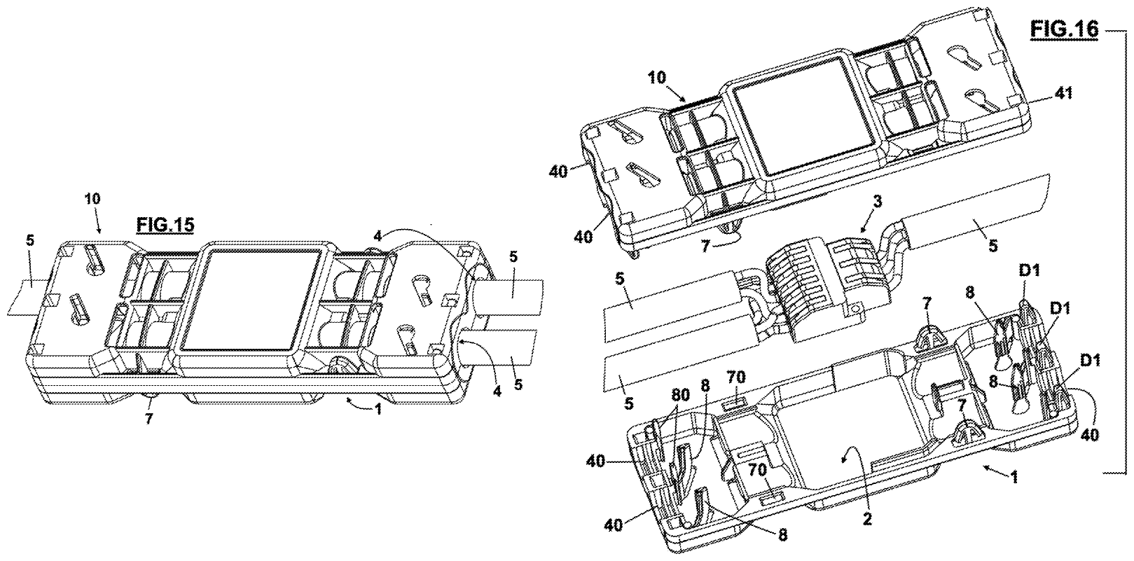

FIG. 15 shows a perspective view of a box-shaped protection for electrical connections according to a further embodiment of the present invention in assembled condition;

FIG. 16 is an exploded perspective view of the box-like protection of FIG. 15;

FIG. 17 is a top view of a half-shell of the box-like protection of FIG. 15 with a terminal block inside to which an electric cable is connected;

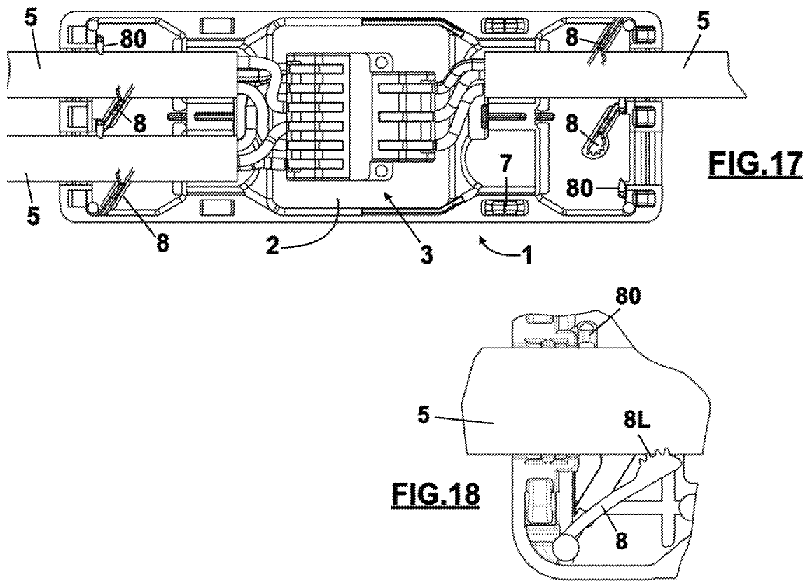

FIG. 18 is an enlarged detail of FIG. 17.

Reduced to its essential structure and with reference to the example shown in FIGS. 1-10, a box-like protection (PS) for electrical connections in accordance with the present invention comprises two half-shells (1, 10) which, in cooperation with each other, define an internal seat (2) for a terminal block (3) or similar device for making electrical connections, and two openings (4) for the electric cables (5) connected to the terminal block (3). In this example, the openings (4) are coaxial with each other.

With reference to the embodiment shown in the drawings, the openings (4) are circular and are defined by semi-circular recesses (40) formed on the end heads (41) of each half-shell (1, 10). It is understood, however, that the shape of the openings (4) can be non-circular but, for example, square or rectangular. The geometric axis defines an entry/exit direction for the respective electric cable (5). In practice, each opening (4) of the box-like protection (PS) is formed by two corresponding halfopenings (40) when the two half-shells are placed one on top of the other.

Each half-shell (1, 10) has an internal area (6) shaped so as to be able to receive the terminal block (4) which, in the assembled box-like protection configuration, is entirely housed inside the latter. Furthermore, each half-shell (1, 10) has two sides (42) which, together with the head ends (41), define the perimetral edge of the halfshell itself.

The two half-shells (1, 10) are intended to be coupled to each other. For example, each half-shell has an anchor (7) and an anchoring window (70) on each side (42). With reference to the enclosed exemplary drawings, each half-shell has two anchors (7) in mirror-image positions and two anchoring windows (70) also in mirror-image positions on the sides (42). The anchors (7) are formed by elements comprising a stem (71) projecting orthogonally from the respective side (42) and two flexible wings (72) diverging with respect to the stem and facing said side (42). In this case, the mutual coupling of the half-shells (10) is obtained by inserting the anchors (7) of one half-shell into the anchoring windows (70) of the other half-shell until the wings (72) come out and, spreading apart after their approaching due to their passing through the anchoring windows (70), cause the mutual locking of the half-shells. The windows (70) guide the correct insertion of the anchors (7).

The half-shells (1, 10) can be mutually locked in any other way (for example using screw means) but the use of snap coupling means of the type described above is preferable because it helps to simplify the assembly of the box-shaped protection making faster the assembly operations.

A box-like protection (PS) for electrical connections according to the present invention is provided with a cable locking mechanism.

In accordance with the example shown in the drawings, the cable locking mechanism of a box-like protection (PS) for electrical connections in accordance with the present invention comprises, on an inner side of each head of each halt-shell (1, 10), a flexible arm (8) having a free end facing the geometric axis (A4) of a respective semi-opening (40) and a fixed abutment (80) formed in front of said arm (8) on the opposite side with respect to the same axis (A4). In accordance with the example shown in the accompanying drawings, each arm (8) is preferably oriented along a diagonal direction (A8) with respect to said axis (A4) and has a free end (8L) facing the respective half-opening (40). Therefore, any traction force exerted on the cable automatically causes a greater flexion of the arm (8) and therefore the compression of the cable against the abutment (80). In other words, any traction exerted on the cable (5) causes, by the elements (8, 80), a compression of the cable itself on opposite sides with respect to the axis (A4) of the respective semi-opening (40). Preferably, said free end (8L) is grooved. The arm (8) and the fixed abutment (80) formed on the inner side of one semi-opening (40) are arranged on inverted positions with respect to the arm (8) and the fixed abutment (80) formed on the inner side of the other half-opening (40). For example, with reference to FIG. 6, the arm (8) on the inner side of the semi-opening (40) on the left in the figure is below the axis (A4) while the fixed abutment (80) is above the same axis; conversely, the arm (8) on the internal side of the semi-opening (40) on the right in the figure is above the axis (A4) while the fixed abutment (80) is below the axis (A4).

Once the connections between the cables (5) have been made, by means of the terminal block (3), the same cables are each inserted into a respective half-opening (40) of a half-shell (1). During this operation, the arms (8) spread elastically and the respective free ends (8L) move away from the axis (A4) but the arms (8) also exert a lateral pressure on the cables and the latter are therefore clamped between the free ends (8L) of the arms (8) and the corresponding abutments (80). Subsequently, the other half-shell (10) is positioned on the half-shell (1) forming the box-like protection (PS). In this phase, also the arms (8) of the half-shell (10) spread elastically and the respective free ends (8L) move away from the axis (A4) and the arms (8) also exert a lateral pressure on the cables which, therefore, are also clamped between the free ends (8L) of the arms (8) and the respective abutments (80) of the half-shell (10). Therefore, on the inner side of the openings (4) each cable (5) is clamped between two arms (8) and two abutments (80) which compress the cable laterally. In other words, each cable (5) is clamped on four points on opposite positions and the clamping points are formed by the two arms (8) and by the two abutments (80). Therefore, a more effective locking of the cables (5) is achieved regardless of the cross-section of the cables themselves, ensuring greater adaptability of the box-like protection to the cables used.

In practice, on the inner side of the openings (4), i.e. on the side of the openings (4) facing the seat (2) for the terminal block (3), a clamping mechanism is arranged comprising clamping elements formed in each half-shell on opposite sides with respect to the same openings (4). Said clamping elements are configured to laterally clamp the cables passing through the openings (4).

With reference to the example shown in the attached drawings, the aforesaid clamping elements consist of the flexible arms (8) and the respective abutments (80) arranged on each half-shell (1, 10).

A dielectric gel (per se known) can be introduced into the box-like protection.

Preferably, each half-shell (1, 10) has two opposite walls (43), each of which protrudes orthogonally from a corresponding side (42) of the half-shell near the seat (2); at a position adjacent to each of the walls (43) each half-shell (1, 10) also has a recess (44) the profile of which is the same as that of the walls (43). When the halfshells (1, 10) are superimposed, the edges of the walls (43) of one half-shell fit into the recesses (44) of the other half-shell. Therefore, when the half-shells (1, 10) are superimposed, said walls (43) laterally surround the terminal block (3) arranged in the seat (2), isolating the latter from the entry of dust or other materials from the outside.

In the drawings, the references “DI” and “F10” respectively denote two teeth protruding from a half-shell (1) and two opposing windows formed on the other half-shell (10) in correspondence with the head ends (41) which favor a more stable association of the half-shells themselves.

For example, the half-shells (1, 10) can be made by molding Nylon P66 loaded with glass fiber, or by molding a per se known self-extinguishing material. After forming the half-shells (1, 10), the respective seats (2) intended to house the terminal block, or equivalent connector, are filled with a dielectric gel.

In the embodiment shown in FIGS. 11-14, the half-shells (1, 10) are configured such that the box-like protection has only one opening (4) for the passage of a cable (5). Also in this example, the single opening (4) is defined by a recess (40) formed on a head end (41) of each half-shell. In this example, the head end opposite to the one with the recess (40) is a closed head end, i.e. without passages. In this configuration, the clamping mechanism defined by the previously described elements (8, 80) is formed on a single head end (41). The mutual coupling system of the half-shells (1, 10) is identical to that described with reference to the first example.

In the embodiment illustrated in FIGS. 15-18, the half-shells (1, 10) are configured so that the box-like protection has two openings (4) for passage for two corresponding cables on each of its sides. In this example, on each half-shell (1, 10) the box-like protection has two recesses (40) on each head end (41). In this case, on each end head (41) of each of the half-shells there are two clamping mechanisms (8, 80) on the sides of the two recesses (40). The mutual coupling system of the half-shells (1, 10) is identical to that described with reference to the first example. From the description provided above, it is evident that a box-like protection for electrical connections according to the present invention comprises two half-shells (1, 10) that, in cooperation with each other, define an internal seat (2) for a terminal block (3) or similar device for making electrical connections, and at least one opening (4) for the entry/exit of electric cables (5) connectable to the terminal block (3), and comprising an internal cables-locking mechanism, wherein said internal cables-locking mechanism is a clamping mechanism comprising elements (8, 80) formed, inside each half-shell (1, 10), on opposite sides with respect to said at least one opening (4), wherein a clamping element (8) consists of a movable body and the other clamping element (80) consists of a fixed body such that I correspondence of said at least one opening (4) there are two movable clamping bodies (8) and two fixed clamping bodies (80) adapted to clamp a respective cable (5) on four clamping points.

From the description provided above, it is also evident that a box-like protection for electrical connections according to the present invention may also comprise one or ore of the following features even combined with each other:
said at least one opening (4) is formed by half-openings (40) exhibited by each half-shell (1, 10), and said clamping elements comprise a flexible arm (8) and a fixed stop (80) formed on opposite sides of the half-openings (40).
the half-shells (1, 10) are identical to each other.
said flexible arm (8) has a free end (8L) provided with grooves.
said flexible arm (8) is oriented diagonally towards an axis (A4) of the respective half-opening (40) and has a free end facing the same half-opening.
the half-shells (1, 10) are provided with mutual snap coupling means.
the clamping elements (8, 80) form an elastic clamping mechanism in which one of the clamping elements consists of an elastically flexible body oriented towards an axis (A4) of the respective opening (4).

In practice, the execution details can in any case vary in an equivalent manner as regards the individual elements described and illustrated, without thereby departing from the adopted solution and therefore remaining within the limits of the protection granted by the present patent in accordance with the following claims.

1-7. (canceled)

8. A box-like protection for electrical connections, comprising: two half-shells that, in cooperation with each other, define an internal seat for a terminal block (for making electrical connections, and at least one opening for the entry/exit of electric cables connectable to the terminal block, and comprising an internal cables-locking mechanism, wherein the said internal cables-locking mechanism is a clamping mechanism comprising elements formed, inside each half-shell, on opposite sides with respect to said at least one opening, wherein a clamping element has a movable body and the other clamping element has a fixed body such that in correspondence of said at least one opening there are two movable clamping bodies and two fixed clamping bodies adapted to clamp a respective cable on four clamping points.

9. The box-like protection according to claim 8, wherein said at least one opening is formed by half-openings exhibited by each half-shell, wherein said clamping elements comprise a flexible arm and a fixed stop formed on opposite sides of the half-openings.

10. The box-like protection according to claim 8, wherein the half-shells are identical to each other.

11. The box-like protection according to claim 9, wherein said flexible arm has a free end provided with grooves.

12. The box-like protection according to claim 9, wherein said flexible arm is oriented diagonally towards an axis of the respective half-opening and has a free end facing the same half-opening.

13. The box-like protection according to claim 8, wherein the half-shells are provided with mutual snap coupling means.

14. The box-like protection according to claim, 8 wherein the clamping elements form an elastic clamping mechanism in which one of the clamping elements consists of an elastically flexible body oriented towards an axis of the respective opening.
